(19) United States
(12) Patent Application Publication
(10) Pub. No.: US 2023/0008772 A1
(43) Pub. Date: Jan. 12, 2023

(54) SPINNERET, BLOWING SYSTEM AND METHOD FOR PRODUCING HOLLOW FIBERS

(71) Applicant: University of Kentucky Research Foundation, Lexington, KY (US)

(72) Inventor: Matthew Weisenberger, Lexington, KY (US)

(21) Appl. No.: 17/858,652

(22) Filed: Jul. 6, 2022

Related U.S. Application Data
(60) Provisional application No. 63/219,780, filed on Jul. 8, 2021.

(51) Int. Cl. D01D 5/24; D01D 5/06; D01D 10/06; B29C 48/05; B29C 48/10; B29C 48/32

(52) U.S. Cl. CPC D01D 5/24; B29C 48/05; B29C 48/10; B29C 48/32; D01D 5/06; D01D 10/06

(57) ABSTRACT

A spinneret and system are provided for microfilm blowing of hollow polymer fibers. The spinneret includes a gaseous fluid passageway and a polymer dope passageway wherein the gaseous fluid passageway is inside the polymer dope passageway. Gaseous fluid is expelled from the gaseous fluid passageway within an annulus of polymer dope extruded from an extrusion opening of the spinneret. The extruded polymer dope is blown up and expanded by the gaseous fluid to form a hollow fiber with unique characteristics.

### RELATED APPLICATIONS

This application claims the benefit of U.S. Provisional Patent Application Serial No. 63/219,780, filed on Jul. 8, 2021, the full disclosure of which is incorporated herein by reference.

### TECHNICAL FIELD

This document relates generally to the polymer fiber production field, and, more particularly, to a new and improved spinneret, a new and improved hollow fiber microfilm blowing system and to a related method for efficiently producing high quality, hollow polymer fibers, many of which having unique characteristics.

### BACKGROUND

Hollow fibers are desired for a number of technologies ranging from medical (dialyses) to structural (lightweight) and thermal (insulating) applications. However, the processing of small dimension hollow fibers (wall thicknesses ~ 10 micron and less; and outer diameters ~ 50 micron and less) becomes complicated.

Achieving small dimensions is hypothesized to enable much faster throughput production of hollow carbon fiber (kg/hr), and with significantly enhanced mechanical properties for incredibly high tensile properties per unit density of fiber. At present, such a hollow carbon fiber does not commercially exist. Current technologies that get close attempt to utilize multicomponent spinning with a sacrificial polymer.

The micro-film blowing approach disclosed in this document utilizes a shaped spinneret hole through which microtubing is concentrically press-fit. This tubing does not communicate with the polymer flow which creates the hollow fiber wall, but separately communicates with an air flow which will be used to “blow the fibers up like a bubble”. This allows for the formation of thin wall hollow fibers, which is key to their performance. Moreover, this allows for spinning of the polymer dope or solution directly into higher concentrations of solvent in water, which will dramatically increase fiber quality.

### SUMMARY

In accordance with the purposes and benefits set forth herein, a new and improved spinneret is provided for producing hollow fibers from a polymer dope. The spinneret comprises, consists of or consists essentially of a body including a reservoir and at least one extrusion opening in communication with the reservoir. The at least one extrusion opening includes an outer wall and an inner wall. A gaseous fluid passageway is defined within the inner wall and a polymer dope passageway is defined between the inner wall and the outer wall whereby gaseous fluid from the gaseous fluid passageway is expelled within an annulus of polymer dope exiting from the at least one extrusion opening.

In at least one of the many possible embodiments of the spinneret, the polymer dope passageway extends concentrically around the gaseous fluid passageway.

In at least one of the many possible embodiments of the spinneret, the spinneret further includes microtubing received at least partially within the at least one extrusion opening and forming the inner wall. The spinneret may also include securing flanges for holding the microtubing within the outer wall of the at least one extrusion opening. The securing flanges may project inwardly from the outer wall. In at least some embodiments, the securing flanges include a plurality of symetrically spaced sections projecting inwardly from the outer wall and the polymer dope passageway is defined between the inner wall, the outer wall and the plurality of spaced sections of the securing flange.

In at least one embodiment, the spinneret further includes a gaseous fluid delivery manifold carried on the body in communication with the gaseous fluid passageway. In at least one embodiment, the gaseous fluid delivery manifold extends concentrically around the reservoir and a delivery port extends through the outer wall to provide communication between the gaseous fluid delivery manifold and the gaseous fluid passageway within the microtubing.

In at least one of the many possible embodiments, the gaseous fluid flow through the spinneret is isolated from the polymer dope flow through the spinneret whereby mass flow of polymer dope and mass flow of gaseous fluid through the spinneret may be independently controlled.

In accordance with yet another aspect, a new and improved hollow fiber microfilm blowing system is provided,. That hollow fiber microfilm blowing system comprises, consists of or consists essentially of: (a) a source of polymer dope, (b) a source of gaseous fluid, (c) a spinneret including a gaseous fluid passageway positioned inside a polymer dope passageway, (d) a first mass flow controller adapted for independently controlling mass flow of polymer dope through the polymer dope passageway of the spinneret, and (e) a second mass flow controller adapted for independently controlling mass flow of gaseous fluid through the gaseous fluid passageway of the spinneret.

In at least one of the many possible embodiments of the hollow fiber microfilm blowing system, the spinneret comprises a body including a reservoir and at least one extrusion opening in communication with the reservoir. The at least one extrusion opening includes an outer wall and an inner wall. The gaseous fluid passageway is defined within the inner wall and the polymer dope passageway is defined between the inner wall and the outer wall whereby gaseous fluid from the gaseous fluid passageway is expelled within an annulus of polymer dope exiting from the at least one extrusion opening. The gaseous fluid flow through the gaseous fluid passageway of the spinneret is isolated from the polymer dope flow through the polymer dope flow passageway of the spinneret whereby the mass flow of polymer dope and the mass flow of gaseous fluid through the spinneret may be independently controlled.

In accordance with yet another aspect, a new and improved method is provided for microblowing hollow fibers. That method comprises, consists of or consists essentially of the steps of extruding an annulus of polymer dope through at least one extrusion opening in a spinneret; and simultaneously blowing a gaseous fluid within the annulus of polymer dope whereby the annulus of polymer dope is blown outward into a hollow fiber having a distinct lumen and relatively thin sidewall. More specifically, the polymer dope is extruded through the spinneret at a first mass flow rate and the gaseous fluid is blown through the spinneret at a second mass flow rate.

In at least one possible embodiment of the method, the method further includes the step of independently controlling the first mass flow rate of the gaseous fluid and the second mass flow rate of the polymer dope to control a lumen diameter and a wall thickness of the hollow fiber.

In at least one possible embodiment of the method, the method further includes the step of delivering the extruded annulus of polymer dope to a coagulation bath. In at least one possible embodiment of the method, the method further includes the step of drying the hollow fiber.

Still further, the method may include the step of selecting the gaseous fluid from a group of gases consisting of an inert gas, air, nitrogen, carbon dioxide, argon, helium, ammonia gas, a reactive gas, monomeric gases and combinations thereof and/or selecting the polymer for the polymer dope from a group of polymer materials consisting of polyacrylonitrile (PAN), polysulfone (PS), polyethersulfone (PES), a filament forming polyamide polymer, a filament forming polyester polymer, a filament forming polyolefin polymer, a filament forming polystyrene polymer and combinations thereof. The monomeric gases of interest may be polymerized inside the hollow fiber to create a coating of polymer inside the lumen.

In the following description, there are shown and described several preferred embodiments of the spinneret, the hollow fiber microblowing system and the related method of microblowing hollow fibers. As it should be realized, the spinneret, the system and the method are capable of other, different embodiments and their several details are capable of modification in various, obvious aspects all without departing from the spinneret, system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the spinneret, the hollow microfilm blowing system and the related method of microblowing hollow fibers and together with the description serve to explain certain principles thereof.

FIG. 1 is a top plan view looking down into one possible embodiment of the spinneret sans microtubing.

FIG. 2 is a cross sectional view of the spinneret illustrated in FIG. 1 also sans microtubing.

FIG. 3 is a detailed cross sectional view of one extrusion opening in communication with the polymer dope reservoir of the spinneret.

FIG. 4 is a detailed, transverse cross sectional view along line 4-4 of the extrusion opening illustrated in FIG. 3.

FIG. 5 is a block schematic of the hollow fiber microfilm blowing system incorporating the spinneret of FIGS. 1-4.

FIG. 6 is a schematic representation of the hollow fiber as it is swelling outward from the force of the gaseous fluid pressing against the annulus of polymer dope following extrusion from the spinneret.

Reference will now be made in detail to the present preferred embodiments of the spinneret, the system and the method, examples of which are illustrated in the accompanying drawing figures.

### DETAILED DESCRIPTION

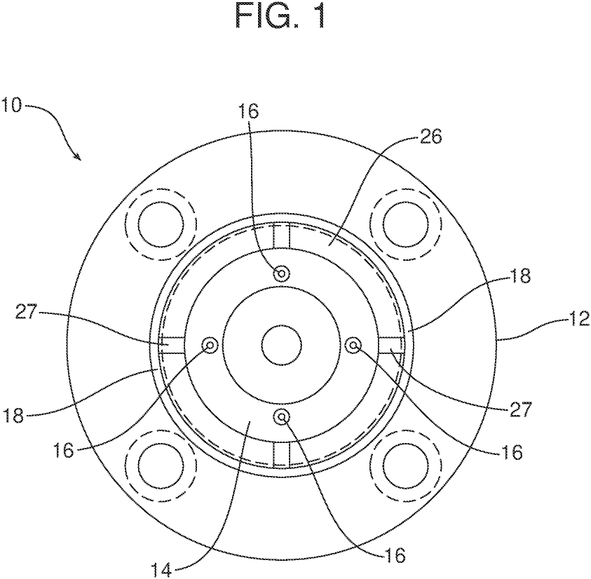

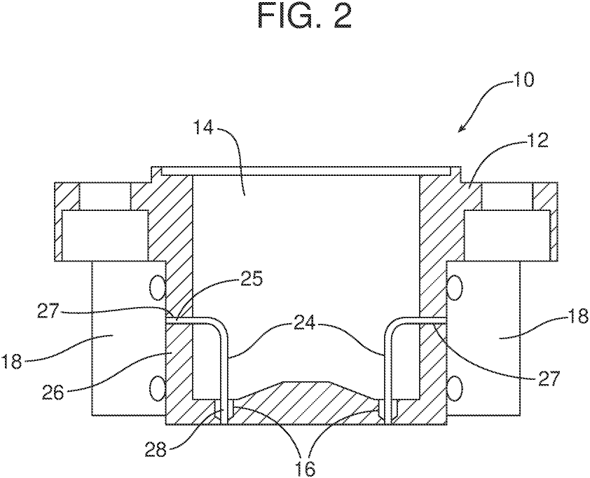

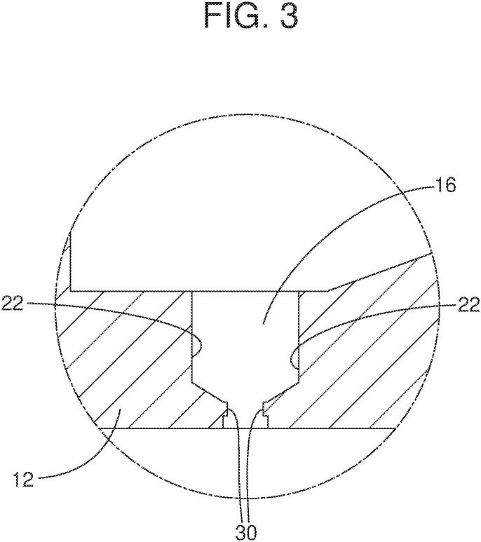

Reference is now made to FIGS. 1-4 that illustrate the new and improved spinneret 10 adapted for microblowing of hollow fibers from a polymer dope. As is known in the art, the polymer dope may comprise the polymer, to be processed, dispersed in an appropriate solvent.

The spinneret 10 includes a body 12 having a polymer dope reservoir 14 and at least one extrusion opening 16. In the illustrated embodiment, four extrusion openings 16 are provided. Other embodiments of the spinneret 10 could include fewer or more extrusion openings 16. A gaseous fluid delivery manifold 18 is carried on or formed as a part the body 12. In the illustrated embodiment, the gaseous fluid manifold 18 extends concentrically around the polymer dope reservoir 14.

Each extrusion opening 16 has an inlet end in communication with the polymer dope reservoir 14. Each extrusion opening 16 includes an inner wall 20 and an outer wall 22. In the illustrated embodiment, the inner wall 20 is formed by a section of microtubing 24. Each section of microtubing has (a) a first end 25 in communication with the gaseous fluid delivery manifold 18 through a delivery port 27 in the outer wall 26 of the polymer dope reservoir 14 and (b) a second end 28 extending into and at least partially received within the associated extrusion opening 16. It is this second end 28 portion of the microtubing 24 that forms the inner wall 20 of the associated extrusion opening 16.

Securing flanges 30, into which the microtubing 24 is press fit, hold the microtubing 24 within the outer wall 22 of each extrusion opening 16. More specifically, the securing flange 30 projects inwardly from the outer wall 22, engaging the second end 28 and holding it in position by press fit/friction fit. In the illustrated embodiment, each securing flange 30 comprises three spaced sections that project inwardly from the outer wall 22.

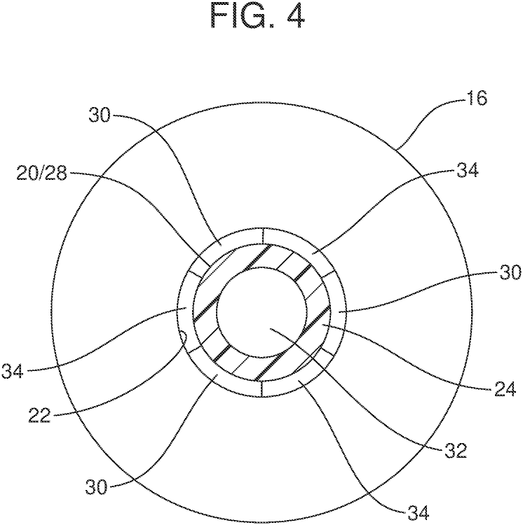

A gaseous fluid passageway 32 is defined within the microtubing 24/inner wall 20 of each extrusion opening 16. A polymer dope passageway 34 is defined between the inner wall 20 and the outer wall 22. More specifically, the polymer dope passageway 34 is defined between the inner wall 20, the outer wall 22 and the spaced sections of the securing flange 30 . See Particularly FIG. 4.

As a result of this structural arrangement, (a) the gaseous fluid delivery manifold 18 and the gaseous fluid passageway 32 are isolated from (b) the polymer dope reservoir 14 and the polymer dope passageway 34. This allows for independent control of the mass flow of gaseous fluid and the mass flow of polymer dope through the spinneret 10.

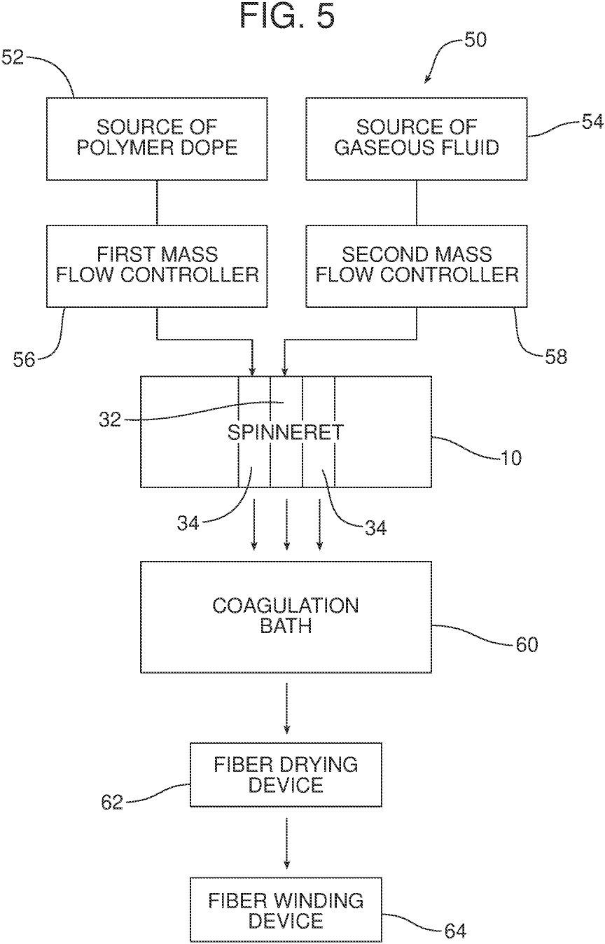

Reference is now made to FIG. 5 which schematically illustrates a hollow fiber microfilm blowing system 50 that incorporates the spinneret 10 described above and illustrated in FIGS. 1-4.

The hollow microfilm blowing system 50 includes a source of polymer dope 52 and a source of gaseous fluid 54. The polymer dope is a dispersion of a polymer in an appropriate solvent. The polymer may comprise, but is not necessarily limited to, polyacrylonitrile (PAN), polysulfone (PS), polyethersulfone (PES), a filament forming polyamide polymer, a filament forming polyester polymer, a filament forming polyolefin polymer, a filament forming polystyrene polymer and combinations thereof. Useful gases for use as the gaseous fluid include, but are not necessarily limited to an inert gas, air, nitrogen, carbon dioxide, argon, helium, ammonia gas, a reactive gas, monomeric gases and combinations thereof. The monomeric gases of interest may be polymerized inside the hollow fiber to create a coating of polymer inside the lumen.

A first mass flow controller 56 is provided in communication with the source of polymer dope 52 and is adapted for independently controlling the mass flow of polymer dope from the source of polymer dope, to the polymer dope reservoir 14 and through the polymer dope passageway 34 of the spinneret 10. A second mass flow controller 58 is provided in communication with the source of gaseous fluid 54 and is adapted for independently controlling the mass flow of gaseous fluid from the source of gaseous fluid, to the gaseous fluid delivery manifold 18 and through the gaseous fluid passageway 32 of the spinneret 10.

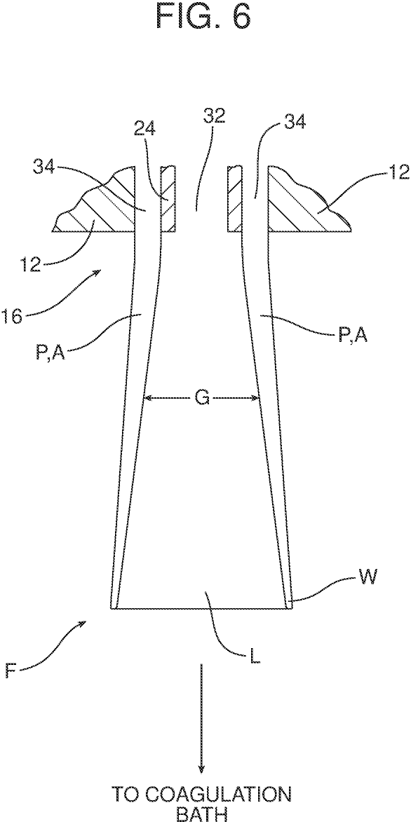

As illustrated in FIG. 6, when the gaseous fluid G exits the second end 20 of the microtubing 24, the gaseous fluid is expelled interior to an annulus A of polymer dope P exiting from the extrusion opening 16. This causes the annulus A of polymer dope P to swell outward like a bubble, creating a hollow fiber F with a distinct lumen L and a thin wall W. Hollow fibers with wall thicknesses of 10 microns or less may be efficiently made using the spinneret 10, the hollow microfilm blowing system 50 and the method disclosed in this document.

The hollow fibers exiting the spinneret 10 are fed into a coagulation bath 60 . The coagulation bath 60 is of a type known in the art and may include, for example, 0.1 to 80% volume polar solvent and 20-99.9% volume non-solvent. The polar solvent may be selected from a group of polar solvents including, but not necessarily limited to, dimethyl sulfoxide, ethylene glycol, glycerol, dimethylacetimide, dimethylformamide, dissolved salts in water including zinc chloride and sodium thiocyanante and combinations thereof. The non-solvent may be selected from a group of non-solvents including, but not necessarily limited to, water, acetone, isopropanol and combinations thereof.

Next, the hollow fibers are fed to a drying device 62 to dry the fibers. Drying devices 62 of a type known in the art for this purpose include an oven, heated rollers or a combination of the two. Air temperatures in the oven may range from, for example, 100-250° C. Following drying, the hollow fibers may be fed to a winding device 64 of a type known in the art and wound on a roller or spool.

In some embodiments of the hollow microfilm blowing system 50, a wash bath (not shown) is provided downstream from the coagulation bath 60 and upstream from the fiber drying device 62. The wash bath functions to wash solvents and chemicals from the hollow fibers in a manner known in the art.

In still other embodiments, a stretch bath (not shown) may be provided downstream of the optional wash bath and upstream from the fiber drying device 62. The stretch bath, of a type known in the art, may include a polar solvent, such as dimethyl sulfoxide, ethylene glycol, glycerol, water, steam and combinations thereof, maintained at a temperature of between, for example, 0-150° C. while the fibers are stretched at a ratio between perhaps 0.9:1 and 5: 1.

As should be appreciated, the spinneret 10 and hollow microfilm blowing system 50 described above are useful in a method of microblowing hollow fibers. That method may be broadly described as including the steps of extruding an annulus A of polymer dope P through at least one extrusion opening 16 in a spinneret 10 and simultaneously blowing a gaseous fluid G within the annulus A of polymer dope P whereby the annulus of polymer dope is blown outward into a hollow fiber having a distinct lumen and a relatively thin sidewall.

The method may be further described as including the steps of extruding the polymer dope through the spinneret 10 at a first independently controlled mass flow rate and extruding the gaseous fluid through the spinneret at a second independently controlled mass flow rate. By independently controlling the mass flow rates of the polymer dope and the gaseous fluid, it is possible to control the lumen diameter and the wall thickness of the resulting hollow fiber. Thus, it is possible to tailor the hollow fiber produced to meet different specifications best suited for the ultimate application for the hollow fiber.

The method may also be said to include the step of delivering the extruded annulus A of polymer dope P to a coagulation bath 60 to complete the formation of the hollow fiber. In addition, the method may also include the optional steps of washing the hollow fiber in a wash bath and stretching the hollow fiber in a stretch bath. The hollow fiber is then subjected to a drying step as described above.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “an extrusion opening”, as used herein, may also refer to, and encompass, a plurality of extrusion openings.

Each of the following terms: “includes”, “including”, “has”, “having”, “comprises”, and “comprising”, and, their linguistic / grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ± 10 % of the stated numerical value.

Although the spinneret 10, hollow microfilm blowing system 50 and related method of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A spinneret for producing hollow fibers from a polymer dope, comprising:
a body including a reservoir and at least one extrusion opening in communication with the reservoir, the at least one extrusion opening including an outer wall and an inner wall, a gaseous fluid passageway defined within the inner wall and a polymer dope passageway defined between the inner wall and the outer wall whereby gaseous fluid from the gaseous fluid passageway is expelled within an annulus of polymer dope exiting from the at least one extrusion opening.

2. The spinneret of claim 1, wherein the polymer dope passageway extends concentrically around the gaseous fluid passageway.

3. The spinneret of claim 2, further including microtubing received at least partially within the at least one extrusion opening and forming the inner wall.

4. The spinneret of claim 3, further including securing flanges for holding the microtubing within the outer wall of the at least one extrusion opening.

5. The spinneret of claim 4, wherein the securing flanges project inwardly from the outer wall.

6. The spinneret of claim 5, wherein the securing flanges include a plurality of symmetrically spaced sections projecting inwardly from the outer wall.

7. The spinneret of claim 6, wherein the polymer dope passageway is defined between the inner wall, the outer wall and the plurality of spaced sections of the securing flange.

8. The spinneret of claim 7, further including a gaseous fluid delivery manifold carried on the body in communication with the gaseous fluid passageway.

9. The spinneret of claim 8 wherein the gaseous fluid flow through the spinneret is isolated from the polymer dope flow through the spinneret whereby mass flow of polymer dope and mass flow of gaseous fluid through the spinneret may be independently controlled.

10. The spinneret of claim 8, wherein the gaseous fluid delivery manifold extends concentrically around the reservoir and a delivery port extends through the outer wall to provide communication between the gaseous fluid delivery manifold and the gaseous fluid passageway within the microtubing.

11. A hollow fiber microfilm blowing system, comprising:
a source of polymer dope;
a source of gaseous fluid;
a spinneret including a gaseous fluid passageway positioned inside a polymer dope passageway;
a first mass flow controller adapted for independently controlling mass flow of polymer dope through the polymer dope passageway of the spinneret; and
a second mass flow controller adapted for independently controlling mass flow of gaseous fluid through the gaseous fluid passageway of the spinneret.

12. The hollow fiber microfilm blowing system of claim 11, wherein the spinneret comprises a body including a reservoir and at least one extrusion opening in communication with the reservoir, the at least one extrusion opening including an outer wall and an inner wall, the gaseous fluid passageway defined within the inner wall and the polymer dope passageway defined between the inner wall and the outer wall whereby gaseous fluid from the gaseous fluid passageway is expelled within an annulus of polymer dope exiting from the at least one extrusion opening.

13. The hollow fiber microfilm blowing system of claim 12, wherein the gaseous fluid flow through the gaseous fluid passageway of the spinneret is isolated from the polymer dope flow through the polymer dope flow passageway of the spinneret whereby the mass flow of polymer dope and the mass flow of gaseous fluid through the spinneret may be independently controlled.

14. A method of microblowing hollow fibers, comprising:
extruding an annulus of polymer dope through at least one extrusion opening in a spinneret; and
simultaneously blowing a gaseous fluid within the annulus of polymer dope whereby the annulus of polymer dope is blown outward into a hollow fiber having a distinct lumen.

15. The method of claim 14, wherein the polymer dope is extruded through the spinneret at a first mass flow rate and the gaseous fluid is blown through the spinneret at a second mass flow rate.

16. The method of claim 15, including independently controlling the first mass flow rate of the gaseous fluid and the second mass flow rate of the polymer dope to control a lumen diameter and a wall thickness of the hollow fiber.

17. The method of claim 14, including delivering the extruded annulus of polymer dope to a coagulation bath to form a hollow fiber.

18. The method of claim 17, including drying the hollow fiber.

19. The method of claim 14, including selecting the gaseous fluid from a group of gases consisting of an inert gas, air, nitrogen, carbon dioxide, argon, helium, ammonia gas, a reactive gas, monomeric gases and combinations thereof.

20. The method of claim 14, including selecting a polymer for the polymer dope from a group of polymer materials consisting of polyacrylonitrile (PAN), polysulfone (PS), polyethersulfone (PES), a filament forming polyamide polymer, a filament forming polyester polymer, a filament forming polyolefin polymer, a filament forming polystyrene polymer and combinations thereof.
